(19) United States
(12) Patent Application Publication
(10) Pub. No.: US 2007/0058696 A1
(43) Pub. Date: Mar. 15, 2007

(54) APPARATUS AND METHOD FOR MITIGATION OF CROSS CORRELATION IN GPS SYSTEM

(75) Inventors: Andrew G. Dempster, Fyshwick (AU); Eamonn P. Glennon, Fyshwick (AU)

Correspondence Address: GOTTLIEB RACKMAN & REISMAN PC, 270 MADISON AVENUE, 8TH FLOOR, NEW YORK, NY, 100160601, US

(73) Assignee: SigNav Pty Ltd., Fyshwick (AU)

(21) Appl. No.: 11/460,692

(22) Filed: Jul. 28, 2006

Related U.S. Application Data
(60) Provisional application No. 60/703,638, filed on Jul. 29, 2005.

(51) Int. Cl. H04B 1/00

(52) U.S. Cl. 375/148; 375/150

(57) ABSTRACT

A method that is sub-optimal, but easily implemented, for cross correlation mitigation of GPS signals. It involves adaptive modification of the locally generated code used to detect a weak signal so that the new code is orthogonal to the jamming signals currently being tracked. The method employs simple constraints to achieve the orthogonalisation rather than a direct orthogonalisation performed using matrix inversions.

This patent claims priority of U.S. provisional application 60/703,638, filed Jul. 29, 2005, entitled “Novel GPS Cross Correlation Mitigation Technique”, the full disclosure of which is incorporated by reference.

### BACKGROUND OF THE INVENTION

Cross correlations caused by the limited dynamic range of the GPS Gold codes represent a significant problem in the observation of weak GPS signals. This is of particular concern in applications such as assisted GPS for E911 and in the use of GPS for remote sensing where the presence of a single strong GPS signal can make observation of other weaker signals difficult.

The 1023 chip Gold code sequences used for the GPS L1 C/A code signal represent a compromise between achieving good overall cross correlation performance and the conflicting requirement of having a short code length as is required for rapid acquisition. Although this choice works well in most cases, it is problematic for those applications in which large differences in received power occur. In cases where cross correlation problems occur, the locally generated code for a weak signal being searched for has a cross correlation with another present strong satellite signal that can be larger than the detection threshold. This can lead to inadvertent acquisition of the strong signal rather than the desired weak signal leading to false acquisition. Scenarios affected by the ‘near-far’ problem include situations in which pseudolites are employed for GPS augmentation and weak signal GPS where both strong and weak signals must be received. A number of different techniques are available for mitigating cross correlations, with most of these techniques having been developed for CDMA communication systems. E. P. Glennon and A. G. Dempster, “A Review of GPS Cross Correlation Mitigation Techniques,” presented at The 2004 International Symposium on GNSS/GPS, Sydney, Australia, 2004. The methods can be generally separated into two categories, namely cancellation and subspace projection techniques.

Cancellation techniques resolve the problem of cross correlation by subtracting the strong signal from the input signal data-stream before baseband downconversion and de-spreading. The main advantage of cancellation techniques is that they are relatively simple. So long as the strong interfering signal is being tracked and parameters such as signal amplitude, carrier frequency, carrier phase, code frequency, code phase and data-bit modulation are being estimated, it is possible to reconstruct the interfering signal after which it can be subtracted away. Unfortunately, the effectiveness of the method is reduced should the parameter estimates contain errors and the method is further complicated by data-bit modulation that also needs to be accounted for. Failure to properly account for the data-bits can lead to addition of the reconstructed signal rather than subtraction which has the effect of exacerbating any cross correlations. The need to reconstruct the interfering signal also imposes a delay on the subsequent signal processing further complicating the process.

Subspace projection techniques represent an alternative approach to resolving the cross-correlation problem. With these techniques, rather than using a de-spreading code that is matched to the transmitted code of the weak signal, a different code that rejects the strong signal cross correlations while still being able to observe the desired weak signal is used instead, with the new de-spreading code having the property of being able to extract the component of the weak signal subspace that does not lie within the interference subspace. As is the case for the cancellation techniques, subspace projection techniques have not found widespread use within the GPS community. One reported use of the technique is Y. Jade-Morton, Y. B. J. Tsui, D. M. Lin, L. L. Liou, M. Miller, Q. Zhou, M. French, and J. Schamus, “Assessment and Handling of CA Code Self Interference during Weak GPS Signal Acquisition,” presented at Proceedings of the 16th International Technical Meeting of the Satellite Division of the U.S. Inst. Of Navigation, Portland, Oreg., 2003, while its applicability to GPS is also referred to in J. K. Thomas, W. Kober, E. Olsen, and K. Krumvieda, “Interference Cancellation in a Signal.” United States of America: Tensorcomm, Incorporated, 2004. The reason for the method not being widely used is due to the difficulty in constructing the required codes in real time, with the code construction technique requiring a significant amount of matrix arithmetic on vectors and matrices that have a length defined by the number of samples in each C/A code epoch. Since each code-delay correlator finger represents a separate de-spreading code vector, it is also necessary for the process to be repeated on each finger, with this further complicating the process.

### BRIEF DESCRIPTION OF THE INVENTION

The invention comprises a GPS receiver performing an algorithm to mitigate cross correlations between multiple satellite signals. Unlike standard subspace projection methods, the invention uses constraints to modify the locally generated codes and does not require the inversion of large matrices. This advantage is gained at a cost of a slight reduction in sensitivity since some components of the weak signal will be lost. Since the number of chips requiring modification is reasonably small for a C/A code PRN code, in the case of one or two jammers it is possible to satisfy these constraints for the typical range of Doppler and PRN code phases. The method is attractive because it does not require estimation of the strong signal amplitude and is partially independent of the data-bit value (except during a data-bit transition which can be considered as a change in the code).

### BRIEF DESCRIPTION OF THE DRAWINGS

FIG. 1 depicts the stages of Signal Processing in a GPS Receiver

FIG. 2 depicts I, Q and Magnitude Cross Correlations before mitigation of the cross correlations for a single jammer, i.e. a single strong signal.

FIG. 3 depicts I, Q and Magnitude Cross Correlations after mitigation of the cross correlations for a single jammer.

FIG. 4 depicts I, Q and Magnitude Cross Correlations before mitigation of the cross correlations for a three jammer situation.

FIG. 5 depicts I, Q and Magnitude Cross Correlations after mitigation of the cross correlations for a three jammer situation.

FIG. 6 shows partial accumulated cross correlations between strong and weak PRN codes.

### DETAILED DESCRIPTION OF PREFERRED EMBODIMENTS

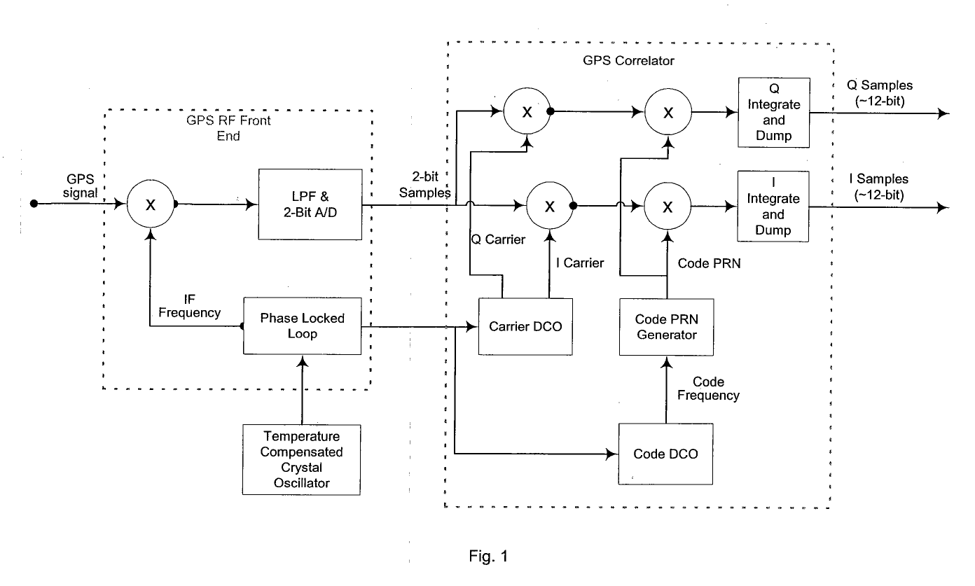

The present invention is a method implemented in a GPS receiver having a processor to execute the steps of the described algorithm. The stages of signal processing in such a receiver are depicted in FIG. 1. For use with such a receiver, gold codes are spreading codes that are constructed to have an upper limit on the cross correlations size. As such, this family of codes has found widespread use, including use within GPS as C/A spreading codes. Nonetheless, despite this design property cross correlations still occur. Table I shows the size of normalised cross correlations between two Gold codes with zero Doppler, where n is the number of shift register stages used to construct the code.

TABLE 1
Gold code cross correlaton properties

| | | Normalized Cross | |
|---|---|---|---|
| Code Length | n | Correlation Level | Probability |
| P = 2ⁿ − 1 | N even | −(2^{(n + 2)/2} + 1)/P | ⅛ |
| | n ≠ 4 i | −1/P | ¾ |
| | | (2^{(n + 2)/2} − 1)/P | ⅛ |
| 1023 | 10 | −65/1023 | ⅛ |
| | | −1/1023 | ¾ |
| | | 63/1023 | ⅛ |

In the case of GPS where n is 10, it can be seen that for 75% of the code phases, there is negligible cross correlation, but for the other 25% the dynamic range is limited to approximately 24 dB.

Given two binary pseudo-random sequences (PRN) c_{w}(i) and c_{sM}(i) both of length N, the cross correlation between the two sequences CC_{cw.csM} may be calculated as

$${cc}_{cw \cdot csM} ( i ) = {c}_{w} ( i ) \cdot {c}_{sM} ( i ) \\ {CC}_{cw \cdot csM} ( j ) = {\sum }_{i = 1}^{j} {cc}_{cw \cdot csM} ( i ) \\ {CC}_{cw \cdot csM} = {CC}_{cw \cdot csM} ( N ) \qquad ( 1 )$$

where j∈[1,N], a w subscript refers to a weak signal PRN and an sM subscript refers to strong signal PRN number M. A weak signal is any signal that has a power level less than the cross correlation threshold of 24 dB below the strong signal. CC_{cw.csM}(j) denotes a partial cross correlation.

Clearly, a non-zero cross correlation CC_{cw.csM} occurs because the cross correlation sequence cc_{cw.csM}(i) is unbalanced, which means the number of 1's is different to the number of −1's. This immediately suggests a method by which the cross correlations may be mitigated, namely modifying the weak PRN c_{w} to some other code ĉ_{w} so that the new cross correlation sequence cc_{ĉw.csM} is balanced.

For cases of single and multiple strong signals the problem is how to generate a new code ĉ_{w} that eliminates the cross correlations with either a single strong signal cₛ₁ or multiple strong signals cₛ₁, cₛ₂ . . . while still being able to observe the required weak signal. Although there are many potential candidates for ĉ_{w} depending on the selection criteria, the preferred embodiment is a simple scheme capable of being used in real GPS receivers. Algorithms are first provided for the case of zero Doppler frequency offsets. A further embodiment describes how Doppler effects can be handled.

Single Strong Jammer

The first embodiment deals with a single strong GPS signal that interferes with the acquisition and tracking of weaker signals. In this embodiment, it is assumed that the strong signal is being tracked and as such, the code sequence for the strong signal cₛ₁(i) is available. Since cross correlations are a form of structured interference, the noise is inherently predictable for a given location, with the prediction of the noise being easier in the case of zero Doppler. Furthermore, since the changes in code phase due to Doppler frequency are relatively slow (even if the Doppler frequency was not zero), the change in the cross correlation sequences are also relatively slow and do not change significantly between code epochs.

One simple method to generate the required code is to make immediate changes to the starting code until the cross correlation has been reduced to the required level. To do this, the cross correlation for the next epoch is pre-calculated thereby determining the amount of change required to eliminate the cross correlation. This is followed by the modification process, which for a single C/A code jammer requires approximately 32 chips in a sequence of 1023 chips be modified since the cross correlation level is either −65 or 63. Chips that need to be changed can be determined through examination of the cross correlation sequence cc_{cw.cs1}, with the aim of ensuring that the sum of the sequence after a full epoch is driven to zero. In the case where the cross correlation is positive (63), the cross correlation sequence has more ones than minus ones and it is necessary to invert the sign of approximately 32 ones. This can be achieved by inverting the sign of 32 chips in c_{w}, where the indices of the chips to be inverted are determined by the indices at which cc_{cw.cs1} have values of one. A similar set of changes is made for a negative cross correlation except that this time it is necessary to create more ones in cc_{cw.cs1}. This gives rise to the following algorithm:

1. Calculate the cross correlation for the next C/A code epoch CC_{cw.cs1} and store the value in a register CC. This involves summation over a full epoch of the output bits of the cross correlation sequence elements cc_{cw.cs1}(j). For a one-bit c_{w} and c_{cs1}, cc_{cw.cs1} may be calculated as an EXCLUSIVE-OR and the summation performed using a counter.

2. For the current C/A code epoch being mitigated, calculate the cross correlation sequence elements cc_{cw.cs1}(j). These values are used in step 5b and 5c.

3. At the start of the C/A code epoch, start the process of generating the modified code ĉ_{w} by setting ĉ_{w} to c_{w}.

4. Set the sample weighting-factor W to 2. W will have a different value if the samples per chip is not 1.

5. For each chip j in the C/A code sequence
a. If the magnitude of CC is less than the desired threshold then do nothing and break from the loop.
b. If CC>0 and cc_{cw.cs1}(j)>0 then
   ĉ_{w}(j)=−ĉ_{w}(j) and CC=CC−W
(for 1-bit ĉ_{w}, this is a ‘bit-flip’).
c. If CC<0 and cc_{cw.cs1}(j)<0 then
   ĉ_{w}(j)=−ĉ_{w}(j) and CC=CC+W.

With this algorithm, no changes will be necessary 75% of the time since significant cross correlations only occur with a probability of 25%. During this 25%, only a small number of chips need to be changed to significantly reduce the cross correlation level, albeit at the cost of a small reduction in sensitivity since ĉ_{w} is no longer matched to c_{w}. These changes are independent of the value of any navigation message data-bits since the effect of the data-bit value is simply to change the sign of the resulting cross correlation, which is driven to zero anyway. However, problems will be experience when a data-bit change occurs since this can be considered as an un-modeled change in the strong code cₛ₁.

Multiple Strong Jammers

When there are multiple strong signals, the single jammer algorithm fails because the algorithm only allows for a single jamming PRN code. Although it would be possible to use this algorithm where the single strong code is replaced with a linear combination of strong codes, this introduces a dependence on the value of the data-bits thereby negating one of the advantages of the method and therefore is less preferred.

The multiple-jammer problem can be stated as the problem of constructing a code sequence ĉ_{w} such that for each strong signal code cₛ₁, cₛ₂ and cₛ₃ the associated cross correlations CC_{ĉw.cs1}, CC_{ĉw.cs2} and CC_{ĉw.cs3} are reduced to acceptable levels. (This description is given in terms of three jammers, although the extension to other values is straightforward). The single jammer algorithm cannot be individually applied to each of the codes in turn because a partial set of changes to ĉ_{w} to reduce the cross correlation with cₛ₁ may be undone or negated when further changes are made to reduce the cross correlation with cₛ₂ or previously small cross correlations may be exacerbated. As a result, a valid solution will ensure that one set of changes do not interfere with another set of changes.

To show how to achieve this objective, consider the partial cross correlations for each strong signal CC_{cw.cs1}(j), CC_{cw.cs2}(j) and CC_{cw.cs3}(j), where the changes made to ĉ_{w} have the effect of driving CC_{ĉw.cs1}(N), CC_{ĉw.cs2}(N) and CC_{ĉw.cs3}(N) to small values. In the one-jammer case, the changes are such that when CC_{cw.cs1} is positive/negative, some locations at which CC_{cw.cs1}(j) is rising/falling are changed so that CC_{ĉw.cs1}(j) is falling/rising instead. These changes ensure that by the time j reaches N, the partial cross correlation terminates near zero as required. The same concept can also be applied in the case of multiple strong signals, except that the locations at which changes can be made to ĉ_{w} are constrained by the codes of the other strong signals. Suppose that modifications to ĉ_{w} are being made to reduce/increase the cross correlation CC_{ĉw.cs1} with cₛ₁, then provided changes to ĉ_{w} are constrained to those indices that cause CC_{ĉw.cs2} and CC_{ĉw.cs3} to remain unchanged, then the changes will have been beneficial. These constraints on CC_{ĉw.cs2} and CC_{ĉw.cs3} being unchanged can be achieved by only making changes at pairs of indices h and l such that cc_{ĉw.cs2}(h)+cc_{ĉw.cs2}(l) and cc_{ĉw.cs3}(h)+cc_{ĉw.cs3}(l) are 0, but cc_{ĉw.cs1}(h)+cc_{ĉw.cs1}(l) is positive/negative as required. In this particular case, inverting the sign of cc_{ĉw.csK}(h) and cc_{ĉw.csK}(l) by inverting ĉ_{w}(h) and ĉ_{w}(l) for K values of 1, 2 and 3 leaves the cross correlations with 2 and 3 unchanged but improves the cross correlations with 1. The process can then be repeated on each of the strong signals that have a large cross correlation with the weak signal code until all cross correlations are reduced. This algorithm can be restated as follows:

1. Calculate the cross correlation for the next C/A code epoch for each strong signal CC_{cw.cs1}, CC_{cw.cs1} and CC_{cw.cs3} storing the values in registers CC(1), CC(2) and CC(3). These values determine whether adjustments are required and the amount of adjustment. Since c_{w}, cₛ₁, cₛ₂ and cₛ₃ are all one-bit sequences, the associated cross correlation sequences cc_{cw.cs1}(j), cc_{cw.cs2}(j) and cc_{cw.cs3}(j) may be implemented as EXCLUSIVE-OR operations which can then be integrated using a counter.

2. For the current C/A code epoch being mitigated, calculate the cross correlation sequence elements cc_{cw.cs1}(j), cc_{cw.cs2}(j) and cc_{cw.cs3}(j). The values should be added to a first-in first out queue (such as a shift register) and a small history of say R elements stored, where larger values of R increase the likelihood of locating instances where required constraints are satisfied. These elements are used during step 5b and 5c.

3. At the start of the C/A code epoch, initiate the process of generating the modified code ĉ_{w} by setting ĉ_{w} to c_{w}.

4. Set the sample weighting-factor W to 2. W will have a different value if the samples per chip is not 1.

5. For the operation that follows, define two subsets of strong signals K and NOTK, these being the single satellite whose cross correlation is being reduced and the remaining set of signals whose cross correlations need to remain unchanged during this process respectively.

For each strong signal, select element K.

For each chip j in the current strong code sequence

a. If the magnitude of CC(K) is less than the desired threshold then break from the inner loop and continue onto next strong signal.

b. From the history of values from (a), locate indices h and l where cc_{cw.csNOTK}(h)+cc_{cw.csNOTK}(l) is 0 for all the signals in NOTK. For the K strong signal being mitigated, we require cc_{cw.csK}(h)+cc_{cw.csK}(l) be positive/negative depending on the sign of the cross correlation. When pairs of indices are located, then adjust ĉ_{w}(h)=−ĉ_{w}(h), ĉ_{w}(l)=−ĉ_{w}(l) and adjust CC(K) so that its magnitude is reduced by 2×W. For 1-bit codes this is a bit-flip.

One way of selecting a subset of cases for step 5b that satisfies the required constraint is to select those indices h where all the cc_{cw.csNOTK}(h) have the same value and another set of indices l where the value of cc_{cw.csNOTK}(l) is opposite in sign. h can be obtained as the AND product of each of the cc_{cw.csNOTK}, while l can be obtained as the AND product of NOT(cc_{cw.csNOTK}). Any index locations at the output of this process where a 1 is obtained satisfies the required conditions and provided that the for those same h and l indices cc_{cw.csK}(h) and cc_{cw.csK}(l) both have the same sign and the correct value, the bit-flip operation at that location can be applied with the desired effect. This selection technique has the advantage of being easily implemented in hardware.

Doppler Effects

Although both the single jammer and multiple jammer algorithms are capable of reducing cross correlations when the Doppler difference between the strong and weak signals is small, problems quickly become apparent when there is a non-zero Doppler difference. The reasons for these failures are that the in-phase & quadrature cross correlations are different due to different relative Doppler carrier (RDC) terms on each of these channels.

RDC presents a number of different problems for cross correlation mitigation. Firstly, it is clear that these mixing terms can be thought-of as applying different weighting to different segments of the strong PRN code, which means that the rotating jamming PRN code is completely different to the fixed PRN code. In particular, the fixed PRN codes are two bit sequences whereas the mixed PRN codes are analogue signals that are effectively multi-bit. This represents a problem for the algorithm presented here that relies on being able to identify locations within the cross correlation sequences that meet certain constraints, under the assumption that the cross correlations are a function of those cross correlation sequences.

Since the RDC phase varies between C/A code epochs, the strong jamming PRN code is no longer periodic with a single C/A code period since it is modulated by the RDC term. This makes prediction of the next C/A code value difficult since it is necessary to take into account the exact frequency and phase of the RDC mixing terms. Knowledge of the exact frequency and phase of the RDC mixing terms requires that the exact frequency and phase of the strong signal must be obtained, as well as knowing the offset from these values for the mixing being applied to search for the weak signal. The former can be obtained from the strong signal digital controlled oscillator (DCO) phase values, assuming that the DCO is phase locked to the strong signal. The latter can be obtained by differencing the weak DCO phases from the strong DCO phase, with an adjustment included to account for the difference between the I & Q channels. It should also be pointed out that the RDC modulation of the strong PRN code is equivalent to modulation of the strong PRN by the product of a square wave given by the sign of the RDC and a non-negative weighting factor given by the magnitude of the RDC. This serves to reinforce the fact that the RDC completely changes the strong code since even a change of a few elements in phase will result in a completely different strong code.

Another difficulty caused by relative Doppler carrier is that the significance of segments of the PRN code change depending on the phase of the RDC. An extreme case occurs for zero RDC where all of the cross correlation will be in the I channel and none will be in the Q channel. This means that care needs to be taken during the mitigation process to ensure that changes are not made at locations where the weighting of the jamming is low and there is no significant effect on the total amount of cross correlation.

Given these problems, it is strongly preferred that RDC effects be taken into account when performing the mitigation. The first requirement is the need for separate mitigation for both the in-phase and quadrature channels. This means that it is necessary to duplicate the process on each channel, with only the RDC inputs to each of those channels being different thereby resulting in different outputs. Since the final detection process involves taking the magnitude of the in-phase and quadrature correlations, this ensures that the cross correlations in both the in-phase and quadrature channels will be controlled.

The second question is how RDC effects can be incorporated into the solution while still permitting the methods applicable to the non-rotating sequences to be employed. The answer is to construct a more realistic version of the strong code sequence as the product of the sign of the RDC and the original code sequence. Since both are two bit sequences, this can be implemented as an EXCLUSIVE-OR operation. Use of this new sequence rather than the original sequence means that except for a non-negative weighting factor given by the magnitude of the RDC sequence, the constraints and the process of locating these constraints are exactly as previously given. However, care still needs to be taken to ensure that when changes are made, the weighting of those changes is properly accounted for.

### EXAMPLES

To confirm that the proposed techniques are effective in enhancing the observability of weak signals in the presence of strong signals, a MATLAB simulation was created. The use of MATLAB has a number of advantages ranging from having exact truth data of the input signals which are directly specified, through to being able to examine a range of intermediate quantities thereby significantly simplifying the debugging process. Unfortunately MATLAB is not as fast as a native C level software receiver so it is not useful for practical systems. The simulation consists of two steps. The first step consists of the generation of a single epoch (one millisecond) of intermediate frequency (IF) data for all of the specified satellites with specified amplitude, Doppler frequency, carrier phase and code phase. Since only a single epoch of data was generated, these simulations do not consider the effect of data-bit transitions. A single epoch of data is also not sufficient to detect very weak signals in the presence of typical noise, so none of the generated signals include additive white noise, so any noise-like effects in the outputs are due to limitations of the technique. The second step of the simulation is to attempt detection of the weak signals assuming that the strong signals are being properly tracked in a phase-locked loop (PLL) and delay locked loop (DLL). The known truth data from the input simulations were used as a substitute for strong signal PLL and DLL outputs. Detection of the weak signal is specified for a single frequency bin with all code phases being examined at a code-spacing consistent with the IF sample period. Since a real search for a weak signal does not have knowledge of the true weak signal carrier frequency and phase terms, errors for these terms may be-specified in the simulation. The output for all code-phases for the I, Q and magnitude terms are then be displayed.

The sampling and mitigation parameters used for the simulations are given in Table 2, where the CCM Limit term represents the level to which cross correlation are driven, CCM Window size is the amount of previous samples retained for the cross correlation mitigation and the relative Doppler limit is the relative Doppler threshold beneath which no mitigation is performed.

TABLE 2
Sampling and Mitigation Parameters

Test case

| | 1 Jammer | 3 Jammers |
|---|---|---|
| IF Frequency (MHz) | −3.000 | −3.000 |
| Sample Period (μs) | 83.33 | 83.33 |
| Samples/Chip | 11.73 | 11.73 |
| CCM Window Size (chips) | 10 | |
| CCM Limit | 0.002 | 0.002 |
| Relative Doppler Limit | 0.125 | 0.125 |

### Single Jammer Example

The first set of results is for the case of a single jammer with a single weak signal with input signal parameters as given in Table 2.

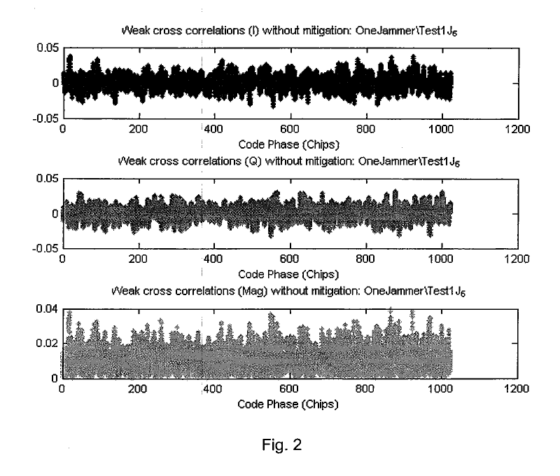

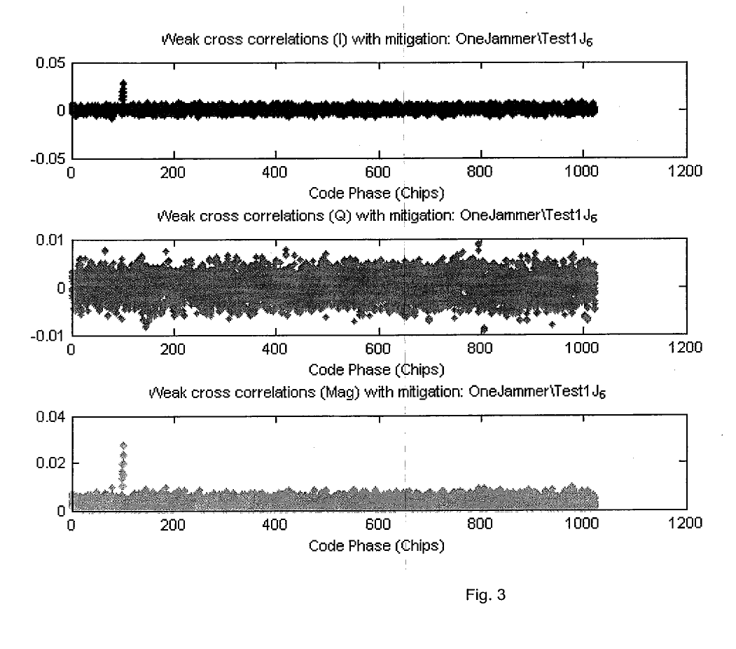

FIG. 2 shows the I (top), Q (middle) and magnitude (bottom) components of the cross correlations as the code phase is varied across the entire code space before application of the mitigation algorithm. FIG. 3 shows the result after application of the algorithm, where the signal at 100 chips is clearly visible.

One feature of these results is a ‘search engine’ noise floor at a magnitude of approximately 0.01 which limits the effectiveness of the technique. Although the CCM limit parameter value of 0.002 was intended to actively limit any residual cross correlation, an investigation into one of the test cases showed that the cause of this noise floor was due to inaccuracies in the estimation of the cross correlation. The inaccuracy was due to a phase-offset between the true cross correlation and the calculated cross correlation of one sample, an error that was similar to the observed noise floor error. This highlights the requirement for accurate prediction of the cross correlations.

Three Jammer Case

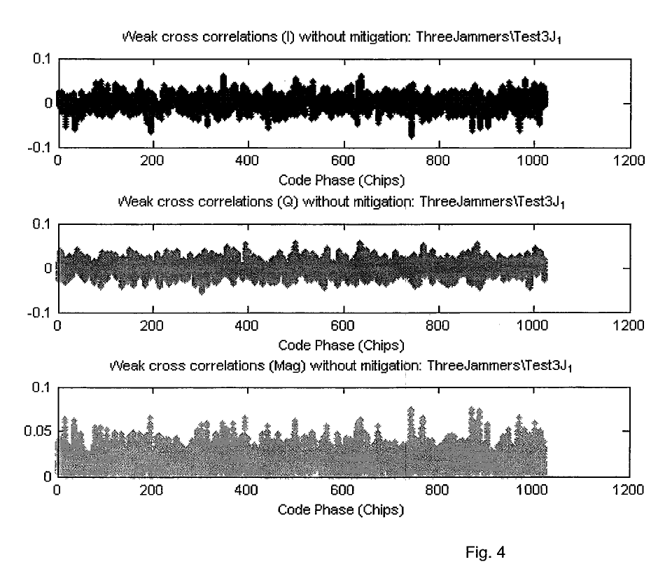

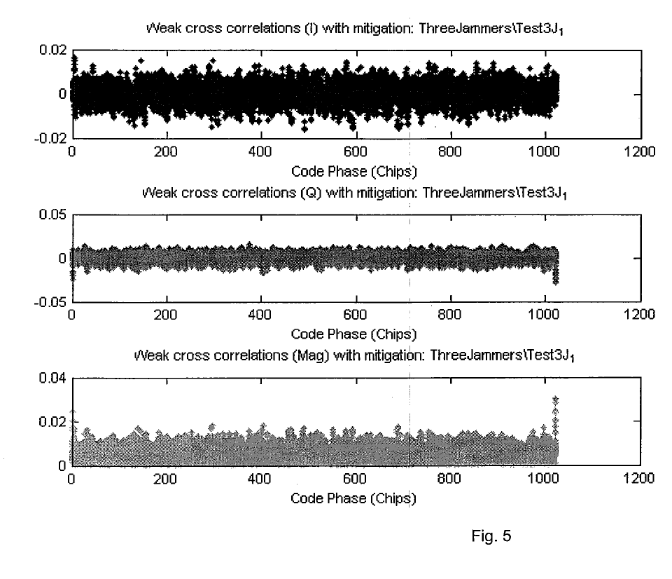

The second set of results is an example of the performance in the case of three jammers with input signal parameters as given in Table 2. As before, FIG. 4 shows the I (top), Q (middle) and magnitude (bottom) components correlations before application of the mitigation followed by the post mitigation results in FIG. 5. In this case, the signal at code phase 0 (1023) with amplitude 0.03 is clearly larger than the correlations at the other code phases. The noise floor at an amplitude of approximately 0.02 is assumed to be due to limitations of the algorithm.

The operation of the process can be examined in closer detail by examining the predicted partial accumulated cross correlations for each satellite before and after application of the PRN code changes for a given code phase.

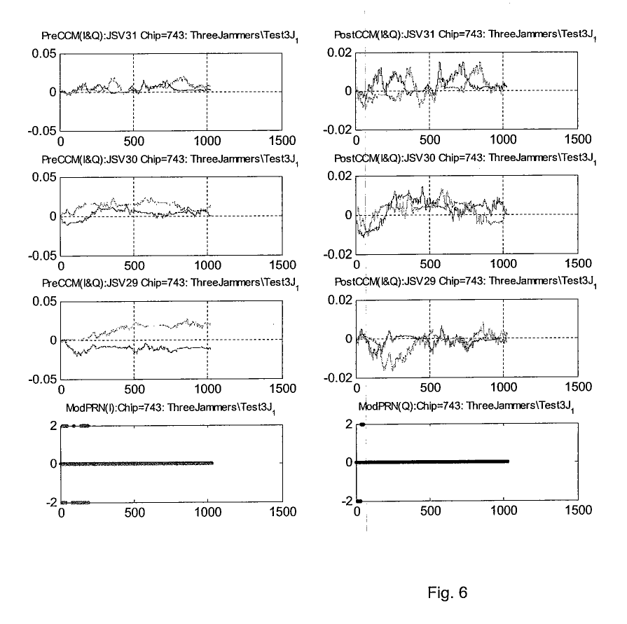

FIG. 6 shows the predicted partial accumulated cross correlations between each strong PRN code and the weak PRN code. The left hand column shows the unmitigated accumulations while the right hand column shows the results after mitigation. The red plots correspond to the I channel while the blue plots show the Q channel. For no cross correlation to occur, it is required that when the ‘sample dump’ occurs at 1023 chips the partial accumulated cross correlation be zero. For the pre-mitigation codes this is not the case, but it can be seen that partial cross correlation has been driven to zero on the right. The bottom row shows the difference between the original weak signal spreading code and the I & Q modified spreading codes. It is clear for this particular example the number of elements in the weak spreading code that were changed was is not excessive.

For a four or five jammer case one might expand the type of changes that may be applied to the locally generated PRN code by removal of the requirement for single bit locally generated codes. If multi-bit locally generated codes were permitted, then not only could the required changes to the PRN codes be made to reduce the cross correlations faster, but the range of constraints that are available to be applied would be increased. For example, rather then being limited to changing the direction of the partial cross correlation when it is moving in the wrong direction, the partial cross correlation could be made to change faster in the desired direction when it was already going in the desired direction. However, this would come at the cost of increased correlator complexity.

Although the invention has been described by reference to specific preferred embodiments, persons of skill in the art will appreciate these are examples of a general concept, which is to be protected by the following claims.

What is claimed is:

1. A GPS receiver performing an algorithm to mitigate cross correlations between strong and weak satellite signals comprising
applying constraints to modify a weak single's locally generated pseudo random code to balance the cross correlation sequence between the weak and a strong pseudo-random codes.

2. The GPS receiver of claim 1, wherein the algorithm calculates a cross-correlation sequences for a data epoch and modifies the next succeeding epoch to balance the cross correlation sequence.

3. The GPS receiver of claim 2 wherein the sum of the sequence is drive to zero.

4. The GPS receiver of claim 2, wherein the algorithm performs the following steps:
(a). calculate the cross correlation for the next C/A code epoch CC_{cw.cs1} and store the value in a register CC.
(b). for the current C/A code epoch being mitigated, calculate the cross correlation sequence elements cc_{cw.cs1}(j).
(c). at the start of the C/A code epoch, begin generating the modified code ĉ_{w} by setting ĉ_{w} to c_{w}.
(d). determine a sample weighting-factor W.
(e). for each chip j in the C/A code sequence
a. If the magnitude of CC is less than a threshold then do nothing and break from the loop.
b. If CC>0 and cc_{cw.cs1}(j)>0 then
ĉ_{w}(j)=−ĉ_{w}(j) and CC=CC−W.
c. If CC<0 and cc_{cw.cs1(j)}<0 then
ĉ_{w}(j)=−ĉ_{w}(j) and CC=CC+W.

5. The GPS receiver of claim 1, wherein the strong pseudorandom code is a linear combination of strong codes.

6. A GPS receiver performing an algorithm to mitigate cross correlations between strong and weak satellite signals comprising applying constraints to modify a weak single's locally generated pseudo random code to balance the cross correlation sequence between the weak and a plurality of strong pseudo-random codes.

7. The GPS receiver of claim 6 wherein the algorithm performs the following steps:
(a). calculate the cross correlation for the next C/A code epoch for each strong signal CC_{cw.cs1}, CC_{cw.cs1} and CC_{cw.cs3} storing the values in registers CC(1), CC(2) and CC(3).
(b) for the current C/A code epoch being mitigated, calculate the cross correlation sequence elements cc_{cw.cs1}(j), cc_{cw.cs2}(j) and cc_{cw.cs3}(j).
(c) at the start of the C/A code epoch, initiate the process of generating the modified code ĉ_{w} by setting ĉ_{w} to c_{w}.
(d). determine a sample weighting-factor W,
(e). define two subsets of strong signals K and NOTK, corresponding to the single satellite whose cross correlation is being reduced and the remaining set of signals whose cross correlations need to remain unchanged during this process respectively.
((f) for each strong signal, select element K.
For each chip j in the current strong code sequence
i. If the magnitude of CC(K) is less than the desired threshold then break from the inner loop and continue onto next strong signal,
ii. from the history of values from (a), locate indices h and l where cc_{cw.csNOTK}(h)+cc_{cw.csNOTK}(l) is 0 for all the signals in NOTK. and adjust ĉ_{w}(h)=−ĉ_{w}(h), ĉ_{w}(l)=−ĉ_{w}(l) and adjust CC(K) so that its magnitude is reduced by 2×W.

8. An algorithm for a GPS receiver to mitigate cross correlations between strong and weak satellite signals comprising
applying constraints to modify a weak single's locally generated pseudo random code to balance the cross correlation sequence between the weak and a strong pseudo-random codes.

9. The algorithm for a GPS receive of claim 8, wherein the algorithm calculates a cross-correlation sequences for a data epoch and modifies the next succeeding epoch to balance the cross correlation sequence.

10. The algorithm for a GPS receiver of claim 9 wherein the sum of the sequence is drive to zero.

11. The algorithm for a GPS receive of claim 9, wherein the algorithm performs the following steps:
(a). calculate the cross correlation for the next C/A code epoch CC_{cw.cs1} and store the value in a register CC.
(b). for the current C/A code epoch being mitigated, calculate the cross correlation sequence elements cc_{cw.cs1}(j).
(c). at the start of the C/A code epoch, begin generating the modified code ĉ_{w} by setting ĉ_{w} to c_{w}.
(d). determine a sample weighting-factor W.
(e). for each chip j in the C/A code sequence
a. If the magnitude of CC is less than a threshold then do nothing and break from the loop.
b. If CC>0 and cc_{cw.cs1}(j)>0 then
ĉ_{w}(j)=−ĉ_{w}(j) and CC=CC−W.
c. If CC<0 and cc_{cw.cs1(j)}<0 then
ĉ_{w}(j)=−ĉ_{w}(j) and CC=CC+W.

12. The algorithm for a GPS receive of claim 8, wherein the strong pseudorandom code is a linear combination of strong codes.

13. A algorithm for a GPS receive to mitigate cross correlations between strong and weak satellite signals comprising
applying constraints to modify a weak single's locally generated pseudo random code to balance the cross correlation sequence between the weak and a plurality of strong pseudo-random codes.

14. The algorithm for a GPS receive of claim 13 wherein the algorithm performs the following steps:
(a). calculate the cross correlation for the next C/A code epoch for each strong signal CC_{cw.cs1}, CC_{cw.cs1} and CC_{cw.cs3} storing the values in registers CC(1), CC(2) and CC(3).
(b) for the current C/A code epoch being mitigated, calculate the cross correlation sequence elements cc_{cw.cs1}(j), cc_{cw.cs2}(j) and cc_{cw.cs3}(j).
(c) at the start of the C/A code epoch, initiate the process of generating the modified code ĉ_{w} by setting ĉ_{w} to c_{w}.
(d). determine a sample weighting-factor W,
(e). define two subsets of strong signals K and NOTK, corresponding to the single satellite whose cross correlation is being reduced and the remaining set of signals whose cross correlations need to remain unchanged during this process respectively.
((f) for each strong signal, select element K.
For each chip j in the current strong code sequence
i. If the magnitude of CC(K) is less than the desired threshold then break from the inner loop and continue onto next strong signal,
ii. from the history of values from (a), locate indices h and l where cc_{cw.csNOTK}(h)+cc_{cw.csNOTK}(l) is 0 for all the signals in NOTK. and adjust ĉ_{w}(h)=−ĉ_{w}(h), ĉ_{w}(l)=−ĉ_{w}(l) and adjust CC(K) so that its magnitude is reduced by 2×W.
